(19) United States
(12) Patent Application Publication
(10) Pub. No.: US 2013/0159273 A1
(43) Pub. Date: Jun. 20, 2013

(54) PROVIDING RELEVANT RESOURCES USING SOCIAL MEDIA AND SEARCH

(71) Applicants: Richard Harvey James Orr, Redmond, WA (US); Dirk Myers, Kirkland, WA (US); Kimberly Maughan Saunders, Kirkland, WA (US); Guillermo Proano, Sammamish, WA (US); Edward James Lehman, Sammamish, WA (US); Jennifer Rowe Lussier, Bothell, WA (US)

(72) Inventors: Richard Harvey James Orr, Redmond, WA (US); Dirk Myers, Kirkland, WA (US); Kimberly Maughan Saunders, Kirkland, WA (US); Guillermo Proano, Sammamish, WA (US); Edward James Lehman, Sammamish, WA (US); Jennifer Rowe Lussier, Bothell, WA (US)

(73) Assignee: MICROSOFT CORPORATION, Redmond, WA (US)

(21) Appl. No.: 13/328,585

(22) Filed: Dec. 16, 2011

(51) Int. Cl. G06F 17/30

(52) U.S. Cl. 707/706; 707/713; 707/728; 707/E17.017; 707/E17.032

(57) ABSTRACT

Embodiments are directed to optimizing searchable resources and to returning relevant search results. In one scenario, a computer system monitors multiple different social media sites to observe conversations related to the searchable resources. The computer system identifies terminology related to the searchable resources from any one or more of the observed conversations. The identified terminology identified may be based on topic, author, and/or place. The computer system then accesses known terminology used to search for the searchable resources and correlates a relationship between the known terminology and the identified terminology. The computer system also modifies the searchable resources to be responsive to a search request that is expressed using the identified terminology.

### BACKGROUND

Computers have become highly integrated in the workforce, in the home, in mobile devices, and many other places. Computers can process massive amounts of information quickly and efficiently. Software applications designed to run on computer systems allow users to perform a wide variety of functions including business applications, schoolwork, entertainment and more. Software applications are often designed to perform specific tasks, such as word processor applications for drafting documents, or email programs for sending, receiving and organizing email.

In some cases, software applications may be designed to interact with other software applications or other computer systems. For example, internet browser applications are designed to send and receive data to and from data servers on the internet. The browser applications allow users to access various forms of content on the internet including World Wide Web content, social media content, web applications, video chatting and more. These various forms of internet content may be accessed directly, or through an internet search website. For instance, if a user wishes to view content on a certain topic, the user enters a search term and various resources deemed most pertinent by the search engine will be returned. However, with the rapid changing of content types, content presentation and even changing language, content that is relevant to the user's search is often overlooked.

### BRIEF SUMMARY

Embodiments described herein are directed to optimizing searchable resources and to returning relevant search results. In one embodiment, a computer system monitors multiple different social media sites to observe conversations related to the searchable resources. The computer system identifies terminology related to the searchable resources from any one or more of the observed conversations. The identified terminology identified may be based on topic, author, and/or place. The computer system then accesses known terminology used to search for the searchable resources and correlates a relationship between the known terminology and the identified terminology. The computer system also modifies the searchable resources to be responsive to a search request that is expressed using the identified terminology.

In another embodiment, a computer system performs a method for returning relevant search results. The computer system receives a search phrase and identifies multiple searchable resources that correspond to the search phrase. The computer system then accesses usage information and/or one or more content measures for each of the identified searchable resources. The usage information and/or one or more content measures are accessed and/or derived from social media conversations related to the search phrase. The computer system also presents search results in response to receiving the search phrase. The search results include each of the searchable resources presented along with the usage information and/or one or more content measures for the searchable resource. The one or more content measures may be provided to assist an owner of searchable resource in determining which searchable resources are to be optimized.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments of the invention may be realized and obtained by means of the instruments and combinations particularly pointed out in the appended claims. Features of the embodiments of the present invention will become more fully apparent from the following description and appended claims, or may be learned by the practice of the invention as set forth hereinafter.

### BRIEF DESCRIPTION OF THE DRAWINGS

To further clarify the above and other advantages and features of embodiments of the present invention, a more particular description of embodiments of the present invention will be rendered by reference to the appended drawings. It is appreciated that these drawings depict only typical embodiments of the invention and are therefore not to be considered limiting of its scope. The embodiments of the invention will be described and explained with additional specificity and detail through the use of the accompanying drawings in which:

FIG. 1 illustrates a computer architecture in which embodiments of the present invention may operate including optimizing searchable resources and returning relevant search results.

FIG. 2 illustrates a flowchart of an example method for optimizing searchable resources.

FIG. 3 illustrates a flowchart of an example method for returning relevant search results.

FIG. 4 illustrates a computer architecture in which relevant search results are determined and provided.

### DETAILED DESCRIPTION

Embodiments described herein are directed to optimizing searchable resources and to returning relevant search results. In one embodiment, a computer system monitors multiple different social media sites to observe conversations related to the searchable resources. The computer system identifies terminology related to the searchable resources from any one or more of the observed conversations. The identified terminology identified may be based on topic, author, and/or place. The computer system then accesses known terminology used to search for the searchable resources and correlates a relationship between the known terminology and the identified terminology. The computer system also modifies the searchable resources to be responsive to a search request that is expressed using the identified terminology.

In another embodiment, a computer system performs a method for returning relevant search results. The computer system receives a search phrase and identifies multiple searchable resources that correspond to the search phrase. The computer system then accesses usage information and/or one or more content measures for each of the identified searchable resources. The usage information and/or one or more content measures are accessed and/or derived from social media conversations related to the search phrase. The computer system also presents search results in response to receiving the search phrase. The search results include each of the searchable resources presented along with the usage information and/or one or more content measures for the searchable resource. The one or more content measures may be provided to assist an owner of searchable resource in determining which searchable resources are to be optimized.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions in the form of data are computer storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM, solid state drives (SSDs) that are based on RAM, Flash memory, phase-change memory (PCM), or other types of memory, or other optical disk storage, magnetic disk storage or other magnetic storage devices, or any other medium which can be used to store desired program code means in the form of computer-executable instructions, data or data structures and which can be accessed by a general purpose or special purpose computer.

A “network” is defined as one or more data links and/or data switches that enable the transport of electronic data between computer systems and/or modules and/or other electronic devices. When information is transferred or provided over a network (either hardwired, wireless, or a combination of hardwired or wireless) to a computer, the computer properly views the connection as a transmission medium. Transmission media can include a network which can be used to carry data or desired program code means in the form of computer-executable instructions or in the form of data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”), and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems that are linked (either by hardwired data links, wireless data links, or by a combination of hardwired and wireless data links) through a network, each perform tasks (e.g. cloud computing, cloud services and the like). In a distributed system environment, program modules may be located in both local and remote memory storage devices.

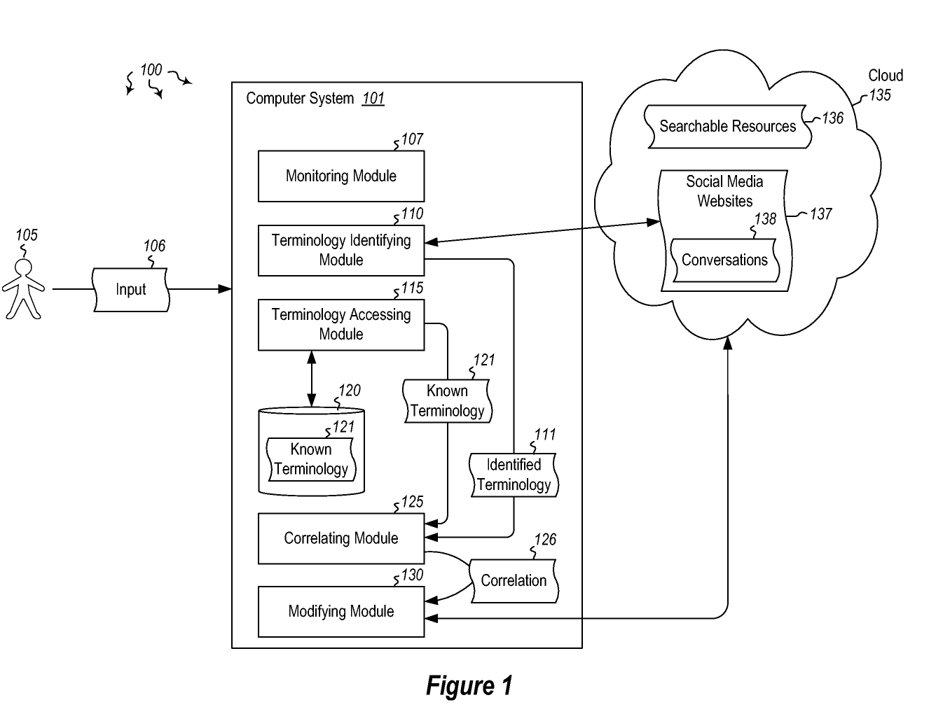

FIG. 1 illustrates a computer architecture 100 in which the principles of the present invention may be employed. Computer architecture 100 includes computer system 101. Computer system 101 may be any type of local or distributed computer system, including a cloud computing system. The computer system includes various different modules for performing a variety of different functions. For instance, monitoring module 107 may monitor conversations 138 on social media websites 137. Other modules may identify and correlate terminology, as will be explained further below.

In some embodiments, computer system 101 uses information from online resources including authorship, publication channel, and topic information to determine a taxonomy for online resources and correlate this knowledge to search phrases. The computer system may also be configured to track references, links, and search engine rank to allow content owners to measure content success and optimization success. Using embodiments described herein, web sites and search engines may present usage information, content measures (e.g., sentiment), and so on with search results, and tailor those results (or the presentation thereof) to an individual user.

Concepts of authorship, influence and observations of social connections between authors may be used to determine useful topics and preferred terminology for a social or web community. Resource owners (e.g. owners of websites, applications, articles, etc.) can discover terminology used in conjunction with known terminology in internet resources or online conversations, as well as discovering terminology that is used by the authors of the resources, independent of a specific resource. In cases where the observed terminology does not match the authoritative terminology, resource creators can then choose to optimize for observed terminology (i.e. the terminology that is actually being used by other internet users to refer to the resource).

Additionally, some web communication mediums, (in particular microblogging, where users send short text message updates to other users that are subscribed to their feed), use terminology that is not generally used in other contexts. Because microblogging sites limit the content that can be published, users create conventions and abbreviations that may not occur in sites that allow longer publications. Embodiments described herein allow resource creators to create mappings between terminology sets to account for differences across communication mediums.

In some cases, mappings may be established between observed terminology, authoritative terminology, and terminology used in search phrases. This enables resource creators to create relevant resources even when the need for the resources is expressed in different terminology than would otherwise be used in search.

One element that may be addressed is discovering unmet resource needs and trending search term activity. By monitoring online conversations associated with a specific community and/or specific topics, systems described herein allow resource owners to discover trending topics (on particular websites, or about a particular topic (e.g. the resource owner's resource)) and potential search terms that do not yet have resources associated with them. This allows resource owners to create resources in a timely manner and to anticipate search term activity.

Embodiments described herein also allow resource owners to indicate preference for certain resources as results for certain search phrases. Systems described herein track ongoing ordering of these results, allowing resource owners to measure whether their efforts at search engine optimization are successful. The resource owners may use the new terminologies discovered to change their search engine optimization settings including search terms and phrases.

Systems described herein may also provide the capability for search result providers or content owners to display relevant conversations and related resources along with search results. The systems allow partitioning of search phrases based on the person searching or the community using the search phrase. This gives search providers the ability to distinguish between identical search phrases and present relevant results. For example, if the person searching has a history of discussing a software product that uses a certain file name extension, the results of a search for that extension can be restricted to only that software product rather than other products that use the same file name extension. Moreover, search providers or sites may be able to display authorship information on results. This helps resource users to gauge the relevance and credibility of the resource.

One long-term technique used to build search rank for a resource is to have high-quality incoming links to the resource. The systems described herein offer resource owners and resource users the ability to respond to ongoing conversations about a certain topic by providing a link to a resource in the conversation. The systems also have the capability of providing recommended resources to link to within a conversation. These recommendations can be based on observed activity, or can be resources that a resource owner has marked as preferred resources. The systems also allow resource owners to refer participants in a conversation to an individual or group to provide an answer. This helps to build authority for that individual or group. In some cases, an existing resource or an individual who can provide an answer may not be available. In these cases, the system has identified an unmet resource need, as described above.

Thus, systems described herein monitor online resources and correlate resources to provide aggregated views and analysis. The systems analyze resources from a variety of incoming data sources and correlate the resources based primarily on topic, author, and place (among other things). Correlation may be further analyzed based on linking and sharing. The systems extract relevant terms from online resources. Users of the system may be able to create relationships between terms that indicate the terms are equivalent, and to associate related terms together. These discovered terms from online resources may be compared to previously-declared taxonomy stored in the system. Moreover, users may be able to associate discovered taxonomy with declared taxonomy.

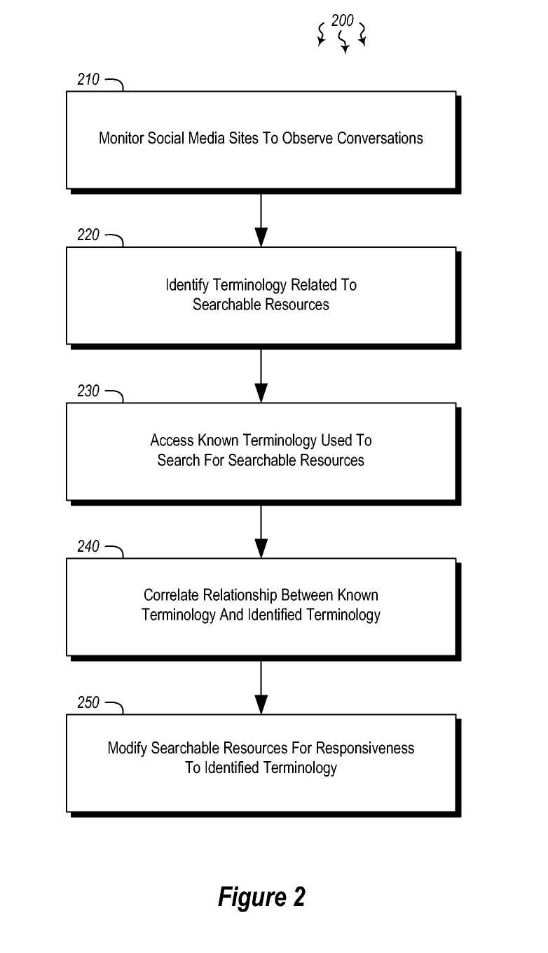

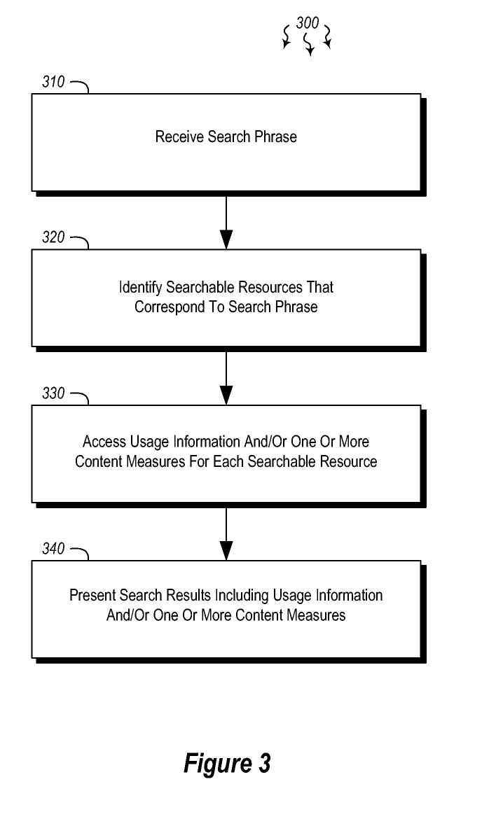

Search term suggestions that are not relevant can be marked irrelevant and ignored in ongoing tracking and analysis. Users may also be able to track resources as they appear in search results, and maintain data on the search ranking for a particular resource within results for a particular search phrase. Resource creators may also be able to see conversations related to a particular resource, including information about the people participating in the conversation and the level of influence those people have within the community. Likewise, for a new resource, resource owners may be able to determine which community members may be most interested in the new resource, and who may be most effective at promoting the resource for contributing to organic optimization for the resource. These concepts will be explained further below with regard to methods 200 and 300 of FIGS. 2 and 3, respectively.

In view of the systems and architectures described above, methodologies that may be implemented in accordance with the disclosed subject matter will be better appreciated with reference to the flow charts of FIGS. 2 and 3. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 2 illustrates a flowchart of a method 200 for optimizing searchable resources. The method 200 will now be described with frequent reference to the components and data of environment 100.

Method 200 includes an act of monitoring a plurality of social media sites to observe conversations related to the searchable resources (act 210). For example, monitoring module 107 may monitor social media websites 137 to observe various conversations 138 related to a searchable resource 136. A social media website may refer generally to any web site or web application or smart phone application or other medium with which internet (i.e. cloud 135) users communicate or view information. This may include microblogging websites or web applications, chat rooms, forums, web sites with comment sections, blogging websites, commercial or private websites, or any other internet-accessible method of providing information. In some cases, different applications or methods of exchanging information (such as microblogging) have their own terminology or communication conventions. These terminologies may change rapidly, and thus may change dramatically over time. The monitoring module thus monitors these various forms of communication to observe what terminology is being used to refer to a specific topic or specific resource.

This monitoring of social media sites and observed conversations related to the searchable resources allow searchable resource owners to discover one or more trending topics related to their searchable resources. Thus, if an owner owned a product such as a technological widget, the owner could monitor how his technological widget is being discussed, what topics related to the widget were popular, and what types of terminology were being used in referring to the widget. Using these monitored observations, a searchable resource owner may discover potential search terms that do not yet have searchable resources associated with them. The owner may then refine his or her search optimization strategies to relate the newly discovered terms with his or her widget or other searchable resource.

Method 200 includes an act of identifying terminology related to the searchable resources from at least one observed conversations, the identified terminology identified based on one or more of: topic, author, and place (act 220). Thus, as mentioned above, new terminology related to the searchable resource 136 may be identified by terminology identifying module 110. A searchable resource owner (e.g. 105) may provide input 106 indicating which type of terminology is to be observed. Thus, for example, an owner may specify that terminology related to a specific topic (his or her widget), terminology used by a specified user or group of users, or terminology used by a specific website or by people in located in a specified location. It should also be noted that any one of a combination of topic, author and place may be used.

Thus, in some cases, the identified terminology 111 applies to a specific internet community, application, website or social media type. The identified terminology may related to some portion of existing, known terminology. A searchable resource owner may already know some of the terms users use when referring to their website or product or when searching for the owner's resource via a search engine (e.g. through commonly provided website hosting analytics). The known terminology 121 (which in some cases may be stored in a local data store 120) may thus be accessed to search for the searchable resource 136 (act 230). A relationship is then correlated (by correlating module 125) between the known terminology and the identified terminology (act 240). The identified terminology may thus be used to identify new searchable resources in addition to those searchable resources that are already related to the known terminology.

In some embodiments, a searchable resource owner may create a mapping between a known terminology set that describes the owner's searchable resource and a different, social media terminology set that describes the owner's searchable resource in different terms. Thus, the correlation 126 created by module 125 may include mappings between known terminology 121 and identified terminology 111. The mappings include any one or more of the following: observed terminology, authoritative terminology and terminology used in search phrases. It should be noted that either or both of the newly identified terminology and the known terminology may include observed, authoritative or search terminology. The mappings allow relevant searchable resources to be provided even when search phrases include different terms than those found in those searchable resources that are determined to be relevant. Thus, if a correlation has been made between a newly identified term and a known term, and the user searches for the newly identified term, the correlation between the terms will ensure that the user sees the owner's searchable resource in the user's search results.

Method 200 also includes an act of modifying the searchable resources to be responsive to a search request that is expressed using the identified terminology (act 250). Thus, as explained above, a resource owner 105 can use modifying module 130 to modify the known terminology accessed by module 115 to include the newly observed terminology 111 (either directly or via a mapping). It should be noted herein that either or both of the computer system 101 and the resource owner 105 may modify the searchable resources to be responsive to a search request that is expressed using the identified terminology. The computer system 101 may also track references to a given searchable resource, track links to a given searchable resource, and/or track search engine rankings for a given searchable resource. These additional resources may be used to further optimize the searchable resource for easy location by a search engine (i.e. search engine optimization). This data may be provided to the searchable resource owners to inform the owner of the searchable resource's current search optimization status (i.e. is the item easily located and correctly organized by a search engine?).

In one example, a computer system may receive a request from a user for searchable resources related to one or more user-provided search terms (e.g. a term related to the resource owner's widget or website). The computer system may determine that the received request includes at least some identified terminology 111 observed by monitoring module 107. The computer system may determine which searchable resources are relevant for the provided search terms using both the known terminology 121 and the identified terminology 111. Then, the computer system may provide the determined relevant searchable resources to the user.

Additionally or alternatively, usage information for the determined relevant searchable resources and/or content measures (e.g., a sentiment ranking) for the determined relevant searchable resources may be provided for the determined relevant searchable resources. Content measures can be derived from social media conversation data. For example, a sentiment ranking for a determined relevant searchable resource can be determined according to one or more of: user reviews about the determined relevant searchable resource, site rankings for the determined relevant searchable resource and social media conversations about the determined relevant searchable resource.

These may be accessed to determine the overall opinion or sentiment toward a product, website or other resource. The resource the user searched for, as well as the additional information, may be tailored to the specific user that sent the request. Thus, depending on the user's identity or membership in a group, or depending on which social media applications the user typically uses, the search results, usage information and/or content measures (e.g., a sentiment ranking) may be provided in a way that is specific to that user.

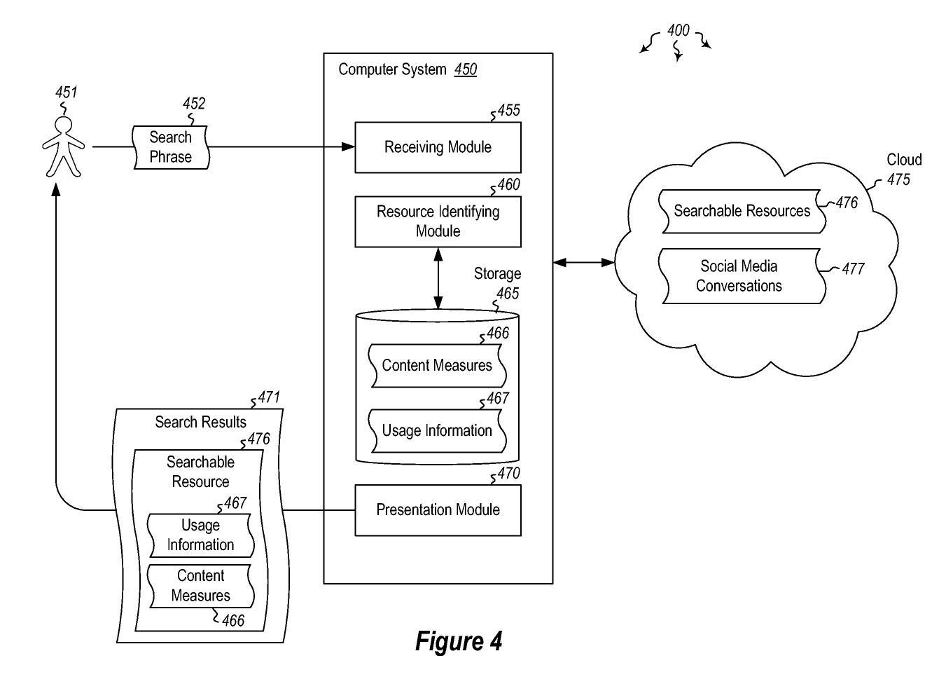

Embodiments may also include receiving a search phrase from a user and returning relevant results to that user. For instance, as shown in FIG. 4, user 451 may send a search phrase 452 to the receiving module 455 of computer system 450. The computer system identifies one or more searchable resources 476 using the search phrase. The computer system may also refine the search results using content measures 466 and/or usage information 467 accessed and/or derived from social media conversations 477 that reference search phrase 452. Thus, relevant search results 471 may be provided to the user, along with any associated usage information. Alternately or in combination, relevant search results 471 may be provided along with one or more categories of content measures, such as, for example, sentiment, topical relevance, topical importance, audience target, author expertise (e.g., to determine appropriate resources to optimize), etc. These concepts will be explained further below with regard to method 300 of FIG. 3 and environment 400 of FIG. 4.

Method 300 includes an act of receiving a search phrase (act 310). For example, receiving module 455 may receive search phrase 452 from user 451. Method 300 includes an act of identifying searchable resources that correspond to the search phrase (act 320). For example, resource identifying module 460 may identify various different searchable resources 476 that correspond to search phrase 452. Thus, if search phrase 452 refers to a person, product, place or other searchable resource, resource identifying module 460 can locate resources related search phrase 452.

In general, different categories of content measures can be used to determine whether a resource is to be optimized. In some embodiments, content measure algorithms are used to derive content measures. The content measure algorithms can, for example, access social media conversations 477. From social media conversations 477, the content measure algorithms can derive content measures. The derived content measures can then be used to determine whether a resource is to be optimzed. A single content measure algorithm can be used to derive multiple categories of content measures, such as, for example, sentiment, topical relevance, topical importance, audience target, author expertise (e.g., to determine appropriate resources to optimize), etc. Alternately, each category of content measure may have a different corresponding content measure algorithm.

Method 300 includes an act of accessing usage information and/or one or more content measures for each searchable resource (act 330). For example, resource identifying module 460 may also access usage information 467 and content measures 466 for each of the identified plurality of searchable resources Usage information 467 and content measures 466 can be accessed and/or derived from content of social media conversations 477 related to search phrase 452. Thus, as explained, when users of social media web sites converse about a topic, whether using known terminology or newly identified terminology, their usage of certain phrases or their rankings or other content measures may be recorded in a local data store (e.g., storage 465) or in a distributed data store (e.g., in cloud 475).

Method 300 includes an act of presenting search results including usage information and/or one or more content measures sentiment (act 340). For example, presentation module 470 of computer system 450 may present search results 471 to the user 451. Results 471 can include the most relevant searchable resources 476 (perhaps ranked according to relevancy), along with the usage information 467 and/or content measures 466. Usage information 467 and content measures 466 may be displayed near or next to each returned searchable resource.

Thus, for example, a user may enter a given search term or phrase 452, and may receive in return a list of relevant results, where each result has usage information and one or more content measure rankings gathered from other social media websites. As such, the relevancy of any given search result may be increased or decreased for the user based on the usage information and/or one or more content measures. If the user notes that a large number of people on certain (perhaps noted in the results) web sites or social media applications (e.g. microblogging applications) are speaking poorly of a searchable resource, as indicated by content measures, it may drop in importance (even if the searchable resource is otherwise relevant). Conversely, if a user notices a large number of people speaking positively about a resource, as indicated by content measures, the importance of that resource (to the user) may go up.

Accordingly, content measures, such as, a sentiment ranking, can be provided to assist a user in determining the importance of a searchable resource. Content measures may also be used to assist a searchable resource owner in determining which searchable resources are to be optimized. In some cases, a searchable resource owner may indicate a preference that one or more specified searchable resources is to be identified as a relevant result when a specified search phrase is entered. Thus, if a certain term related to the user's resource is shown to have a high level of sentiment, the owner can optimize that term for location and use by search engines. In some embodiments, information in addition to the usage information and content measures may be shown next to or near the provide search results 471. For instance, various different social media conversations that are relevant to the search results may be presented in addition to each search result. Furthermore, authorship information indicating the author of each search result may be presented in addition to each search result.

Accordingly, methods, systems and computer program products are provided which optimize searchable resources. Moreover, methods, systems and computer program products are provided which returns relevant search results, along with other usage and content measures.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. At a computer system including one or more processors and system memory, the computer system also including searchable resources that can be returned as search results in response to an appropriate search query, a method for optimizing the searchable resources, the method comprising:
an act of monitoring a plurality of social media sites to observe conversations related to the searchable resources;
an act of identifying terminology related to the searchable resources from at least one observed conversations, the identified terminology identified based on one or more of: topic, author, and place;
an act of accessing known terminology used to search for the searchable resources;
an act of correlating a relationship between the known terminology and the identified terminology; and
an act of modifying the searchable resources to be responsive to a search request that is expressed using the identified terminology.

2. The method of claim 1, further comprising:
an act of receiving a request from a user for searchable resources related to one or more provided search terms;
an act of determining that the received request includes one or more portions of identified terminology;
an act of determining which searchable resources are relevant for the provided search terms using both the known terminology and the identified terminology; and
an act of providing the determined relevant searchable resources to the user.

3. The method of claim 2, wherein at least one of the following is provided in addition to the determined relevant searchable resources: usage information for the determined relevant searchable resources and a sentiment ranking for the determined relevant searchable resources.

4. The method of claim 3, wherein the sentiment ranking is determined according to any one or more of the following: user reviews about the determined relevant searchable resource, site rankings for the determined relevant searchable resource and social media conversations about the determined relevant searchable resource.

5. The method of claim 3, wherein the searchable resource and additional information are tailored to the specific user that sent the request.

6. The method of claim 1, further comprising an act of tracking one or more of the following: references to a searchable resource, links to a searchable resource, and search engine ranking of a searchable resource.

7. The method of claim 6, further comprising providing one or more searchable resource owners with the tracked data to inform the searchable resource owner of the searchable resource's current search optimization status.

8. The method of claim 1, wherein the identified terminology applies to a specific internet community, application, website or social media type.

9. The method of claim 1, wherein the identified terminology is used to identify new searchable resources in addition to those searchable resources that are already related to the known terminology.

10. The method of claim 1, wherein a searchable resource owner creates a mapping between a known terminology set that describes the owner's searchable resource and a different, social media terminology set that describes the owner's searchable resource in different terms.

11. The method of claim 10, wherein the mapping includes at least one of the following: observed terminology, authoritative terminology and terminology used in search phrases.

12. The method of claim 11, wherein the mappings allow relevant searchable resources to be provided even when search phrases include different terms than those found in those searchable resources that are determined to be relevant.

13. The method of claim 1, wherein the monitored social media sites and observed conversations related to the searchable resources allow searchable resource owners to discover one or more trending topics related to the searchable resources.

14. The method of claim 1, wherein the monitored social media sites and observed conversations related to the searchable resources allow searchable resource owners to discover potential search terms that do not yet have searchable resources associated with them.

15. At a computer system including one or more processors and system memory, the computer system also including at least an index of searchable resources related to searchable topics, links to the searchable resources returnable to requestors when the searchable resources corresponding to submitted search phrases, a method for returning relevant search results, the method comprising:
an act of receiving a search phrase;
an act of identifying a plurality of searchable resources that correspond to the search phrase;
an act of accessing one or more of: usage information and one or more content measures for each of the identified plurality of searchable resources, the one or more of: usage information and the one or more content measures derived from social media conversations related to the search phrase; and
an act of presenting search results in response to receiving the search phrase, the search results including each of the plurality of searchable resources presented along with the one or more of: usage information and the one or more content measures for the searchable resource.

16. The method of claim 15, wherein the one or more content measures include a sentiment ranking, the sentiment ranking provided to assist a searchable resource owner in determining which searchable resources are to be optimized.

17. The method of claim 15, wherein at least one searchable resource owner indicates a preference that one or more specified searchable resources is to be identified as a relevant result when a specified search phrase is entered.

18. The method of claim 15, wherein one or more relevant social media conversations are presented in addition to each search result.

19. The method of claim 15, wherein authorship information for each search result is presented in addition to each search result.

20. A computer system comprising the following:
one or more processors;
system memory;
one or more computer-readable storage media having stored thereon computer-executable instructions that, when executed by the one or more processors, causes the computing system to perform a method for optimizing the searchable resources, the method comprising the following:
an act of monitoring a plurality of social media sites to observe conversations related to the searchable resources;
an act of identifying terminology related to the searchable resources from at least one observed conversations, the identified terminology identified based on one or more of: topic, author, and place;
an act of accessing known terminology used to search for the searchable resources;
an act of correlating a relationship between the known terminology and the identified terminology;
an act of modifying the searchable resources to be responsive to a search request that is expressed using the identified terminology;
an act of receiving a request from a user for searchable resources related to one or more provided search terms;
an act of determining that the received request includes one or more portions of identified terminology;
an act of determining which searchable resources are relevant for the provided search terms using both the known terminology and the identified terminology; and
an act of providing the determined relevant searchable resources to the user.
